(19) United States
(12) Patent Application Publication
(10) Pub. No.: US 2008/0233368 A1
(43) Pub. Date: Sep. 25, 2008

(54) ARTICLES HAVING ENHANCED REVERSIBLE THERMAL PROPERTIES AND ENHANCED MOISTURE WICKING PROPERTIES TO CONTROL HOT FLASHES

(75) Inventors: Mark Hartmann, Boulder, CO (US); Greg Roda, Broomfield, CO (US); Guy Eckert, Kennett Square, PA (US)

Correspondence Address: Neugeboren O''Dowd PC, 1227 Spruce Street, SUITE 200, BOULDER, CO, 80302, US

(73) Assignee: OUTLAST TECHNOLOGIES, INC., Boulder, CO (US)

(21) Appl. No.: 12/051,772

(22) Filed: Mar. 19, 2008

Related U.S. Application Data
(60) Provisional application No. 60/895,940, filed on Mar. 20, 2007.

(51) Int. Cl. B32B 9/00; B32B 3/10; B05D 5/00

(52) U.S. Cl. 428/206; 427/265

(57) ABSTRACT

A coated article for providing a phased response to rapid temperature changes, comprises a substrate and a coating disposed on a portion of the substrate. The coating comprises a polymeric material, a first temperature regulating material having a transition temperature between 22° C. and 50° C. and disposed within a first plurality of microcapsules, and a second temperature regulating material having a transition temperature between 25° C. and 45° C. and disposed within a second plurality of microcapsules. The first temperature regulating material and the second temperature regulating material are dispersed in the polymeric material. The coating includes a plurality of regions of discontinuity formed by the coating that create exposed portions of the substrate to provide improved flexibility and air permeability to the coated article and wherein the coating provides a buffered response to rapid temperature changes.

### CROSS REFERENCE TO RELATED APPLICATION

This application is based upon, and claims priority to U.S. Provisional Patent Application No. 60/895,940, entitled Articles Having Enhanced Reversible Thermal Properties and Enhanced Moisture Wicking Properties To Control Hot Flashes, filed Mar. 20, 2007. The entirety of such provisional patent application, including all exhibits and appendices are incorporated herein by reference.

### FIELD OF THE INVENTION

Aspects of the present invention relate to articles having enhanced reversible thermal properties and enhanced water vapor transport properties. More particularly, aspects of the present invention relate to coated articles and/or melt, dry, or solution spun fibers with the ability to show such enhanced reversible thermal properties and water vapor transport properties to control sudden temperature spikes, often referred to as hot flashes.

### BACKGROUND OF THE INVENTION

Coatings containing a phase change material have been applied to fabrics to provide enhanced reversible thermal properties to the fabrics themselves as well as to garments or other everyday products. Typically, microcapsules containing a phase change material are mixed with a polymeric material to form a blend, and this blend is subsequently cured or dried on a fabric to form a continuous coating covering the fabric. While providing desired thermal regulating properties, the continuous coating may lead to undesirable reductions in flexibility, softness, air permeability, and water vapor transport properties. Such materials are described, e.g. in U.S. Pat. Nos. 5,366,801; 6,207,738; 6,217,993; 6,503,976; 6,514,362; and 6,660,667. Methods for the incorporation of phase-change material and microencapsulated phase-change material into fibers, are described, e.g. in U.S. Pat. Nos. 6,855,422; 6,689,466; 4,756,958 and U.S. Patent Application Nos. 20050208300; 20040126555; and 20020054964. The relevant teachings of each of the above references are incorporated herein by reference in their entirety.

A continuously coated fabric tends to be stiff and “boardy,” and the relatively impermeable nature of the continuous coating may substantially diminish the ability of the continuously coated fabric to transport air or water vapor. When incorporated in apparel, such reduced properties of the continuously coated fabric can lead to an inadequate level of comfort for an individual wearing the apparel. To overcome these disadvantages phase change materials have previously been incorporated within individual fibers during the fiber manufacturing process. These fibers than can be used to make fabrics with temperature regulating properties without the above disadvantages of continuous coatings. Encapsulated phase change materials have been incorporated into acrylic and viscose fibers during the fiber manufacturing process. Additional technologies include incorporating encapsulated and non-encapsulated phase change materials in the interstices of viscose and other solution spun fibers during or post fiber manufacturing, or incorporating the phase change materials, either as micro phase separated waxes, polymeric phase change materials or dispersed microcapsules containing the phase change material during melt spinning of thermoplastic fibers such as polyester, nylon, polyolefins, etc.

In the case of reducing or mitigating hot flashes, a controlled temperature regulation combined with rapid removal of perspiration is preferred. No methods or products have been developed to accommodate the rapid temperature spikes observed during such episodes and the corresponding need to remove the increase in perspiration. See, e.g. Pathophysiology and Treatment of Menopausal Hot Flashes at www.medscape.com. It is against this background that the need arose to develop the coated articles and fibers disclosed herein.

### SUMMARY OF THE INVENTION

In accordance with one aspect of an article constructed in accordance with the present invention, a coated article for providing a phased response to rapid temperature changes comprises a substrate and a coating disposed on a portion of the substrate. The coating comprises a polymeric material, a first temperature regulating material having a transition temperature between 22° C. and 50° C. and disposed within a first plurality of microcapsules, and a second temperature regulating material having a transition temperature between 25° C. and 45° C. and disposed within a second plurality of microcapsules. The first temperature regulating material and the second temperature regulating material are dispersed in the polymeric material. The coating includes a plurality of regions of discontinuity formed by the coating that create exposed portions of the substrate to provide improved flexibility and air permeability to the coated article and wherein the coating provides a buffered response to rapid temperature changes.

In accordance with another aspect of an article constructed in accordance with the present invention, a coated article for providing a phased response to rapid temperature changes, comprises a substrate and a coating disposed on a portion of the substrate, wherein the coating comprises a polymeric material and a temperature regulating material having a transition temperature between 22° C. and 50° C. and disposed within a plurality of microcapsules and a plurality of regions of discontinuity formed by the coating. The plurality of regions of discontinuity create exposed portions of the substrate to provide improved flexibility and air permeability to the coated article and wherein the coating provides a buffered response to rapid temperature changes.

In accordance with further aspects of an article constructed in accordance with the present invention, a fabric providing a phased response to rapid temperature changes comprises a first surface and a coating disposed on a portion of the first surface. The coating comprises a first temperature regulating material having a transition temperature between 22° C. and 50° C. and disposed within a first region of the coating, and a second temperature regulating material having a transition temperature between 25° C. and 45° C. and disposed within a second region of the coating, wherein the first temperature regulating material and the second temperature regulating material are dispersed in a polymeric material. The coating forms a plurality of regions of discontinuity creating exposed portions of the first surface to provide improved flexibility and air permeability to the coated article and wherein the coating provides a buffered response to rapid temperature changes.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a substrate that includes a discontinuous coating including a blend of a plurality of microencapsulated phase change materials;

FIG. 2 is a cross section of the coating in FIG. 1;

FIG. 3 is a substrate that includes a discontinuous coating where a plurality of microencapsulated phase change materials are separately located on the substrate;

FIG. 4 is a cross section of the coating in FIG. 3;

FIG. 5 is a schematic diagram showing a method of manufacturing aspects of the present invention;

FIGS. 6A-6C show the various coating screens used in conjunction with FIG. 5;

FIG. 7 is a substrate that includes a plurality of microencapsulated phase change materials that are layered on top of one another;

FIG. 8 is a cross section of FIG. 7; and

FIGS. 9-12 show the results of tests performed in connection with articles constructed or prepared in accordance with aspects of the present invention.

### DETAILED DESCRIPTION

It is known that women entering menopause, pregnant women, and breast cancer patients and men who have had prostrate cancer treatment suffer from what are known as “hot flashes.” During such incidents skin temperatures can climb up to 8° F. (4.4° C.) accompanied by profuse perspiration See, for example, Assessing and Improving Measures of Hot Flashes, National Institute of Health, Bethesda Md., Jan. 20, 2004. To date the only treatments have been dietary restrictions or the use of medications. While clothing designed to wick moisture away from the body is known in various forms, the use of phase change materials as a means of controlling the skin temperature change in this situation has not been previously considered. It has been shown that the right combination and distribution of PCMs can provide a staged temperature buffering effect as the skin temperature rises and then falls. The use of this phased temperature response and by the control of the rate at which heat is absorbed and desorbed from the skin the debilitating effect of this phenomenon can be mitigated. By combining this phased temperature buffering with the rapid moisture wicking fiber/fabric properties of known fibers and fabrics, the physical discomforts of “hot flashes” can be further mitigated or eliminated. It is contemplated that this technology may be applied to both clothing and bedding (mattress pads, sheets, pillowcases, and fill). PCM technology is available today either as paraffin or ester waxes with different melting points and ranges, and generally refers to a material that has the capability of absorbing or releasing heat to adjust heat transfer at or within a temperature stabilizing range. A temperature stabilizing range can include a specific transition temperature or a range of transition temperatures. In some instances, a phase change material can be capable of inhibiting heat transfer during a period of time when the phase change material is absorbing or releasing heat, typically as the phase change material undergoes a transition between two states. This action is typically transient and will occur until a latent heat of the phase change material is absorbed or released during a heating or cooling process. Heat can be stored or removed from a phase change material, and the phase change material typically can be effectively recharged by a source of heat or cold. For certain implementations, a phase change material can be a mixture of two or more materials. By selecting two or more different materials and forming a mixture, a temperature stabilizing range can be adjusted for any desired application. The resulting mixture can exhibit two or more different transition temperatures or a single modified transition temperature when incorporated in the coated articles described herein.

Examples of phase change materials include a variety of organic and inorganic substances, such as alkanes, alkenes, alkynes, arenes, hydrated salts (e.g., calcium chloride hexahydrate, calcium bromide hexahydrate, magnesium nitrate hexahydrate, lithium nitrate trihydrate, potassium fluoride tetrahydrate, ammonium alum, magnesium chloride hexahydrate, sodium carbonate decahydrate, disodium phosphate dodecahydrate, sodium sulfate decahydrate, and sodium acetate trihydrate), waxes, oils, water, fatty acids, fatty acid esters, dibasic acids, dibasic esters, 1-halides, primary alcohols, clathrates, semi-clathrates, gas clathrates, anhydrides (e.g., stearic anhydride), ethylene carbonate, polyhydric alcohols (e.g., 2,2-dimethyl-1,3-propanediol, 2-hydroxymethyl-2-methyl-1,3-propanediol, ethylene glycol, pentaerythritol, dip entaerythritol, pentaglycerine, tetramethylol ethane, neopentyl glycol, tetramethylol propane, 2-amino-2-methyl-1,3-propanediol, monoaminopentaerythritol, diaminopentaerythritol, and tris(hydroxymethyl)acetic acid), polymers (e.g., polyethylene, polyethylene glycol, polyethylene oxide, polypropylene, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyesters produced by polycondensation of glycols (or their derivatives) with diacids (or their derivatives), and copolymers, such as polyacrylate or poly(meth)acrylate with alkyl hydrocarbon side chain or with polyethylene glycol side chain and copolymers including polyethylene, polyethylene glycol, polyethylene oxide, polypropylene, polypropylene glycol, or polytetramethylene glycol), metals, and mixtures thereof. Other examples of phase change materials include those described in the patent application of Magill et al., U.S. Patent Application Publication No. 2005/0208300, entitled “Multi-component Fibers Having Enhanced Reversible Thermal Properties and Methods of Manufacturing Thereof,” the disclosure of which is incorporated herein by reference in its entirety. Further examples of phase change materials include those described in Japanese Patent Application Publication No. 2004-003087, entitled “Thermal Storage Conjugated Fiber and Thermal Storage Cloth Member,” the disclosure of which is incorporated herein by reference in its entirety. In addition, hydrocarbon waxes such as n-heneicosane or fatty acid and their esters such as Thermester 48B supplied by Renewable Alternatives of Columbia, Mo. which show two distinct melting points, and different molecular weight polyethylene glycols are also example of phase change materials contemplated for use in various aspects of the present invention. All of the foregoing may be microencapsulated if needed. Another potential class of PCM's which may be useful in aspects of the present invention include homopolymers, random copolymers, or segmented block copolymers with two distinct melting points. It is anticipated that blends of different materials may be utilized to provide wider phase transition temperature performance can also be used.

Aspects of the present invention may also be utilized in the development of clothing for people who are exposed to extreme changes in temperature and humidity in relatively quick succession, for example, workers working with freezer/refrigerated foods. The use of a staged phase change process can accommodate skin temperature changes in the ranges of 37-42° C. that are experienced during “hot flashes” or from −20 to 37° C. for workers who work with frozen or refrigerated foods.

By way of example only, this staged process is achieved by the use of more than one PCM. The PCM's used would preferably absorb/desorb heat in stages. For example, for the control of hot flashes one PCM could absorb/desorb at a peak of approximately 37° C., while another material would absorb/desorb at a peak of 40° C., and yet another at a peak of 40-42° C. Alternatively a phase change material with a broad melting range could also be used. A similar principle is contemplated for brief exposure to lower temperatures.

It is contemplated that a blend of microencapsulated waxes of different melting points could be used in both water based and melt processed products can be used to achieve a phased temperature response and temperature buffering effect. In addition, waxes or other PCM's or mPCM'S which are melt dispersed and phase separated as independent discrete domains in mono or bicomponent sheath core fibers could achieve the required phased/staged temperature response and temperature buffering effect. All processes presently used to incorporate phase change materials onto or into fibers/fabrics or foams could be used in products constructed in accordance with aspects of the present invention.

Aspects of the present invention are also directed toward modifying or controlling the cool sensation and thermal transfer rate, e.g., how fast does the temperature change or the PCM absorb the “hot flash.” This type of cooling effect is described by Weedall and Goldie in the journal article “The Objective Measurement of the “Cool Feeling” in Fabrics” J. Text. Inst. 2001, 92 Part 1, No.4, pages 379-386.

Aspects of PCMs such as 1) low temperature PCMs feeling cooler than higher temperature PCMs; 2) higher concentrations of PCMs feeling cooler and feeling cooler longer than lower concentrations of PCMs; and 3) the location of PCMs, e.g. PCMs next to the skin with instantaneous thermal transfer feeling cooler than PCMs removed from skin by layers of insulation fabric or an air gap or when inside the fiber may be utilized to address the effects of hot flashes and rapid rises in skin temperature.

In addition, wicking fibers, fabrics or foams which embody the above thermal buffering characteristics can be produced by incorporation of wicking treatments, either topical or included in the process so as to migrate to the surface. For fabrics, plaited constructions can be used where the PCM is incorporated as a fiber into a fabric constructed to place the phase change material against the skin and move the moisture to an absorbable breathable outer layer composed of a natural fiber such as cotton or wool.

PCMs can be incorporated either by fiber or coating. A coating may be incorporated either directly on the surface of a substrate material or may be used in conjunction with the substrate material, for example, by being entrained, immersed or otherwise contained within the substrate. In general, the coating can be either on the surface or within the interstices of the substrate. The substrate may be formed of any suitable material, such as a fibrous material or a polymer. Thus, for example, the substrate can be a natural or synthetic fiber (e.g., a fiber formed of polyester, polyamide, polyacrylic, polylactic acid, polyolefin, polyurethane, natural or regenerated cellulose, silk, or wool), a natural or synthetic filament, a yarn formed of natural or synthetic fibers, a fabric formed of natural or synthetic fibers (e.g., a knitted fabric, a woven fabric, or a non-woven fabric), a film, a polymer, a leather, a cardboard, a paper, or a piece of wood. While not illustrated, it is contemplated that the substrate can be formed so as to include two or more sub-layers, which can be formed of the same material or different materials.

Wicking can be incorporated by either specific synthetic wicking fiber shapes (e.g. Coolmax), permanent wicking additives incorporated into synthetic fibers when they are manufactured. Examples include Traptek® carbon particles, PCM microcapsules or Ciba Irgasurf® HL560. It is known that when PCMs are added to acrylic or viscose fiber the porosity of the fiber structure is increased, which leads to increased wicking. Blends of natural fibers that wick such as cotton, wool, viscose, etc., and specific yarn constructions that aid wicking (dri-release®), and topical treatments, can be incorporated separately or as part of the PCM coating itself.

In general, a phase change material may comprise any substance (or mixture of substances) that has the capability of absorbing or releasing thermal energy to reduce or eliminate heat flow at or within a temperature stabilizing range. The temperature stabilizing range may comprise a particular transition temperature or range of transition temperatures. A phase change material used in conjunction with various embodiments of the present invention will preferably be capable of inhibiting a flow of thermal energy during a time when the phase change material is absorbing or releasing heat, typically as the phase change material undergoes a transition between two states (e.g., liquid and solid states, liquid and gaseous states, solid and gaseous states, or two solid states). This action is typically transient, e.g., will occur until a latent heat of the phase change material is absorbed or released during a heating or cooling process. Thermal energy may be stored or removed from the phase change material, and the phase change material typically can be effectively recharged by a source of heat or cold. By selecting an appropriate phase change material, the coated article or fiber may be designed for use in any one of numerous products.

According to other embodiments of the present invention, the phase change material may be a solid/solid phase change material. A solid/solid phase change material is a type of phase change material that typically undergoes a transition between two solid states (e.g., a crystalline or mesocrystalline phase transformation) and hence typically does not become a liquid during use.

Phase change materials that can be incorporated in the coated article or fiber in accordance with various embodiments of the invention include a variety of organic and inorganic substances. Particularly useful phase change materials include paraffinic hydrocarbons having between 10 to 44 carbon atoms (i.e., C10-C44 paraffinic hydrocarbons). Table 1 provides a list of exemplary C13-C28 paraffinic hydrocarbons that may be used as the phase change material in the coated articles described herein. The number of carbon atoms of a paraffinic hydrocarbon typically correlates with its melting point. For example, n-Octacosane, which contains twenty-eight straight chain carbon atoms per molecule, has a melting point of 61.4° C. By comparison, n-Tridecane, which contains thirteen straight chain carbon atoms per molecule, has a melting point of −5.5° C.

TABLE 1

| Paraffinic Hydrocarbon | No. of Carbon Atoms | Melting Point (° C.) |
|---|---|---|
| n-Octacosane | 28 | 61.4 |
| n-Heptacosane | 27 | 59.0 |
| n-Hexacosane | 26 | 56.4 |
| n-Pentacosane | 25 | 53.7 |
| n-Tetracosane | 24 | 50.9 |
| n-Tricosane | 23 | 47.6 |
| n-Docosane | 22 | 44.4 |
| n-Heneicosane | 21 | 40.5 |
| n-Eicosane | 20 | 36.8 |
| n-Nonadecane | 19 | 32.1 |
| n-Octadecane | 18 | 28.2 |
| n-Heptadecane | 17 | 22.0 |
| n-Hexadecane | 16 | 18.2 |
| n-Pentadecane | 15 | 10.0 |
| n-Tetradecane | 14 | 5.9 |
| n-Tridecane | 13 | −5.5 |

Other useful phase change materials include polymeric phase change materials having transition temperatures suitable for a desired application of the coated article (e.g., from about 22° C. to about 40° C. for clothing applications). A polymeric phase change material may comprise a polymer (or mixture of polymers) having a variety of chain structures that include one or more types of monomer units. In particular, polymeric phase change materials may include linear polymers, branched polymers (e.g., star branched polymers, comb branched polymers, or dendritic branched polymers), or mixtures thereof. A polymeric phase change material may comprise a homopolymer, a copolymer (e.g., terpolymer, statistical copolymer, random copolymer, alternating copolymer, periodic copolymer, block copolymer, radial copolymer, or graft copolymer), or a mixture thereof. As one of ordinary skill in the art will understand, the reactivity and functionality of a polymer may be altered by addition of a functional group such as, for example, amine, amide, carboxyl, hydroxyl, ester, ether, epoxide, anhydride, isocyanate, silane, ketone, aldehyde, or unsaturated group. Also, a polymer comprising a polymeric phase change material may be capable of crosslinking, entanglement, or hydrogen bonding in order to increase its toughness or its resistance to heat, moisture, or chemicals.

According to some embodiments of the invention, a polymeric phase change material may be desirable as a result of having a higher molecular weight, larger molecular size, or higher viscosity relative to non-polymeric phase change materials (e.g., paraffinic hydrocarbons). As a result of this larger molecular size or higher viscosity, a polymeric phase change material may exhibit a lesser tendency to leak from the coating during processing or during end use. In addition to providing thermal regulating properties, a polymeric phase change material may provide improved mechanical properties (e.g., ductility, tensile strength, and hardness) when incorporated in the coating. According to some embodiments of the invention, the polymeric phase change material may be used to form the coating without requiring the polymeric material, thus allowing for a higher loading level of the polymeric phase change material and improved thermal regulating properties. Since the polymeric material is not required, use of the polymeric phase change material may allow for a thinner coating and improved flexibility, softness, air permeability, or water vapor transport properties for the coated article.

For example, polyethylene glycols may be used as the phase change material in some embodiments of the invention. The number average molecular weight of a polyethylene glycol typically correlates with its melting point. For instance, a polyethylene glycol having a number average molecular weight range of 570 to 630 (e.g., Carbowax 600) will have a melting point of 20° C. to 25° C., making it desirable for clothing applications. Other polyethylene glycols that may be useful at other temperature stabilizing ranges include Carbowax 400 (melting point of 4° C. to 8° C.), Carbowax 1500 (melting point of 44° C. to 48° C.), and Carbowax 6000 (melting point of 56° C. to 63° C.). Polyethylene oxides having a melting point in the range of 60° C. to 65° C. may also be used as phase change materials in some embodiments of the invention. Further desirable phase change materials include polyesters having a melting point in the range of 0° C. to 40° C. that may be formed, for example, by polycondensation of glycols (or their derivatives) with diacids (or their derivatives). Table 2 sets forth melting points of exemplary polyesters that may be formed with various combinations of glycols and diacids.

TABLE 2

| | | Melting Point |
|---|---|---|
| | | of Polyester |
| Glycol | Diacid | (° C.) |
| Ethylene glycol | Carbonic | 39 |
| Ethylene glycol | Pimelic | 25 |
| Ethylene glycol | Diglycolic | 17-20 |
| Ethylene glycol | Thiodivaleric | 25-28 |
| 1,2-Propylene glycol | Diglycolic | 17 |
| Propylene glycol | Malonic | 33 |
| Propylene glycol | Glutaric | 35-39 |
| Propylene glycol | Diglycolic | 29-32 |
| Propylene glycol | Pimelic | 37 |
| 1,3-butanediol | Sulphenyl divaleric | 32 |
| 1,3-butanediol | Diphenic | 36 |
| 1,3-butanediol | Diphenyl methane-m,m′- | 38 |
| | diacid | |
| 1,3-butanediol | trans-H,H-terephthalic acid | 18 |
| Butanediol | Glutaric | 36-38 |
| Butanediol | Pimelic | 38-41 |
| Butanediol | Azelaic | 37-39 |
| Butanediol | Thiodivaleric | 37 |
| Butanediol | Phthalic | 17 |
| Butanediol | Diphenic | 34 |
| Neopentyl glycol | Adipic | 37 |
| Neopentyl glycol | Suberic | 17 |
| Neopentyl glycol | Sebacic | 26 |
| Pentanediol | Succinic | 32 |
| Pentanediol | Glutaric | 22 |
| Pentanediol | Adipic | 36 |
| Pentanediol | Pimelic | 39 |
| Pentanediol | para-phenyl diacetic acid | 33 |
| Pentanediol | Diglycolic | 33 |
| Hexanediol | Glutaric | 28-34 |
| Hexanediol | 4-Octenedioate | 20 |
| Heptanediol | Oxalic | 31 |
| Octanediol | 4-Octenedioate | 39 |
| Nonanediol | meta-phenylene diglycolic | 35 |
| Decanediol | Malonic | 29-34 |
| Decanediol | Isophthalic | 34-36 |
| Decanediol | meso-tartaric | 33 |
| Diethylene glycol | Oxalic | 10 |
| Diethylene glycol | Suberic | 28-35 |
| Diethylene glycol | Sebacic | 36-44 |
| Diethylene glycol | Phthalic | 11 |
| Diethylene glycol | trans-H,H-terephthalic acid | 25 |
| Triethylene glycol | Sebacic | 28 |
| Triethylene glycol | Sulphonyl divaleric | 24 |
| Triethylene glycol | Phthalic | 10 |
| Triethylene glycol | Diphenic | 38 |
| para-dihydroxy-methyl | Malonic | 36 |
| benzene | | |
| meta-dihydroxy-methyl | Sebacic | 27 |
| benzene | | |
| meta-dihydroxy-methyl | Diglycolic | 35 |
| benzene | | |

According to some embodiments of the invention, a polymeric phase change material having a desired transition temperature may be formed by reacting a phase change material (e.g., an exemplary phase change material discussed above) with a polymer (or mixture of polymers). Thus, for example, n-octadecylic acid (i.e., stearic acid) may be reacted or esterified h polyvinyl alcohol to yield polyvinyl stearate, or dodecanoic acid (i.e., lauric acid) may be reacted or esterified with polyvinyl alcohol to yield polyvinyl laurate. Various combinations of phase change materials (e.g., phase change materials with one or more functional groups such as amine, carboxyl, hydroxyl, epoxy, silane, sulfuric, and so forth) and polymers may be reacted to yield polymeric phase change materials having desired transition temperatures.

A phase change material can comprise a mixture of two or more substances (e.g., two or more of the exemplary phase change materials discussed above). By selecting two or more different substances (e.g. two different paraffinic hydrocarbons or a hydrocarbon and a glycol) and forming a mixture thereof, a temperature stabilizing range can be adjusted over a wide range for any particular application of the coated article. According to some embodiments of invention, the mixture of two or more different substances may exhibit two or more distinct transition temperatures or a single modified transition temperature.

According to some embodiments of the invention, the temperature regulating material may comprise a containment structure that encapsulates, contains, surrounds, absorbs, or reacts with a phase change material. This containment structure may facilitate handling of the phase change material while offering a degree of protection to the phase change material during manufacture of the coated article or a product made therefrom. Moreover, the containment structure may serve to reduce or prevent leakage of the phase change material from the coated article during end use.

For instance, the temperature regulating material may comprise a plurality of microcapsules that contain a phase change material, and the microcapsules may be uniformly, or non-uniformly, dispersed within the coating. The microcapsules may be formed as shells enclosing the phase change material and may be formed in a variety regular or irregular shapes (e.g., spherical, ellipsoidal, and so forth) and sizes. The microcapsules may have the same or different shapes or sizes. According to some embodiments of the invention, the microcapsules may have a size (e.g., diameter) ranging from about 0.01 to about 100 microns. In one presently preferred embodiment, the microcapsules will have a generally spherical shape and will have a size (e.g., diameter) ranging from about 0.5 to about 3 microns. Other examples of the containment structure may include, by way of example and not by limitation, silica particles (e.g., precipitated silica particles, fumed silica particles, and mixtures thereof), zeolite particles, clay particles, carbon particles (e.g., graphite particles, activated carbon particles, and mixtures thereof), and absorbent materials (e.g., absorbent polymeric materials, superabsorbent materials, cellulosic materials, poly(meth)acrylate materials, metal salts of poly(meth)acrylate materials, and mixtures thereof). For instance, the temperature regulating material may comprise silica particles, zeolite particles, carbon particles, or an absorbent material impregnated with a phase change material.

According to other embodiments of the invention, the temperature regulating material may comprise a phase change material in a raw form (e.g., the phase change material is non-encapsulated, i.e., not micro- or macro-encapsulated). During manufacture of the coated article, the phase change material in the raw form may be provided as a solid in a variety of forms (e.g., bulk form, powders, pellets, granules, flakes, and so forth) or as a liquid in a variety of forms (e.g., molten form, dissolved in a solvent, and so forth). To reduce or prevent leakage of the phase change material, it may be desirable, but not required, that a phase change material used in a raw form is a solid/solid phase change material.

In general, the polymeric material may comprise any polymer (or mixture of polymers) that has the capability of being formed into the coating. According to some embodiments of the invention, the polymeric material may provide a matrix within which the temperature regulating material may be dispersed and may serve to bind the temperature regulating material to the substrate. The polymeric material may offer a degree of protection to the temperature regulating material during manufacture of the coated article or a product made therefrom or during end use. According to some embodiments of the invention, the polymeric material may comprise a thermoplastic polymer (or mixture of thermoplastic polymers) or a thermoset polymer (or mixture of thermoset polymers).

The polymeric material may comprise a polymer (or mixture of polymers) having a variety of chain structures that include one or more types of monomer units. In particular, the polymeric material may comprise a linear polymer, a branched polymer (e.g., star branched polymer, comb branched polymer, or dendritic branched polymer), or a mixture thereof. The polymeric material may comprise a homopolymer, a copolymer (e.g., terpolymer, statistical copolymer, random copolymer, alternating copolymer, periodic copolymer, block copolymer, radial copolymer, or graft copolymer), or a mixture thereof. As discussed previously, the reactivity and functionality of a polymer may be altered by addition of a functional group such as, for example, amine, amide, carboxyl, hydroxyl, ester, ether, epoxide, anhydride, isocyanate, silane, ketone, aldehyde, or unsaturated group. Also, a polymer comprising the polymeric material may be capable of crosslinking, entanglement, or hydrogen bonding in order to increase its toughness or its resistance to heat, moisture, or chemicals.

Exemplary polymeric materials that may be used to form the coating include, by way of example and not by limitation, polyamides, polyamines, polyimides, polyacrylics (e.g., polyacrylamide, polyacrylonitrile, esters of methacrylic acid and acrylic acid, and so forth), polycarbonates (e.g., polybisphenol A carbonate, polypropylene carbonate, and so forth), polydienes (e.g., polybutadiene, polyisoprene, polynorbornene, and so forth), polyepoxides, polyesters (e.g., polycaprolactone, polyethylene adipate, polybutylene adipate, polypropylene succinate, polyesters based on terephthalic acid, polyesters based on phthalic acid, and so forth), polyethers (e.g., polyethylene glycol (polyethylene oxide), polybutylene glycol, polypropylene oxide, polyoxymethylene (paraformaldehyde), polytetramethylene ether (polytetrahydrofuran), polyepichlorohydrin, and so forth), polyfluorocarbons, formaldehyde polymers (e.g., urea-formaldehyde, melamine-formaldehyde, phenol formaldehyde, and so forth), natural polymers (e.g., cellulosics, chitosans, lignins, waxes, and so forth), polyolefins (e.g., polyethylene, polypropylene, polybutylene, polybutene, polyoctene, and so forth), polyphenylenes, silicon containing polymers (e.g., polydimethyl siloxane, polycarbomethyl silane, and so forth), polyurethanes, polyvinyls (e.g., polyvinyl butyral, polyvinyl alcohol, esters and ethers of polyvinyl alcohol, polyvinyl acetate, polystyrene, polymethylstyrene, polyvinyl chloride, polyvinyl pryrrolidone, polymethyl vinyl ether, polyethyl vinyl ether, polyvinyl methyl ketone, and so forth), polyacetals, polyarylates, alkyd based polymers (i.e., polymers based on glyceride oil), and copolymers (e.g., polyethylene-co-vinyl acetate, polyethylene-co-acrylic acid, and so forth).

For certain applications of the coated article, the polymeric material may comprise a polymer (or mixture of polymers) that facilitates dispersing or incorporating the temperature regulating material within the coating. For instance, the polymeric material may comprise a polymer (or mixture of polymers) that is compatible or miscible with or has an affinity for the temperature regulating material. In some embodiments of the invention, this affinity may depend on, by way of example and not by limitation, similarity of solubility parameters, polarities, hydrophobic characteristics, or hydrophilic characteristics of the polymeric material and the temperature regulating material. Such affinity may facilitate incorporation of a more uniform or higher loading level of the temperature regulating material in the coating. In addition, a smaller amount of the polymeric material may be needed to incorporate a desired loading level of the temperature regulating material, thus allowing for a thinner coating and improved flexibility, softness, air permeability, or water vapor transport properties for the coated article. In embodiments where the temperature regulating material comprises a containment structure that contains a phase change material, the polymeric material may comprise a polymer (or mixture of polymers) selected for its affinity for the containment structure in conjunction with or as an alternative to its affinity for the phase change material. For instance, if the temperature regulating material comprises a plurality of microcapsules containing the phase change material, a polymer (or mixture of polymers) may be selected having an affinity for the microcapsules (e.g., for a material or materials of which the microcapsules are formed). For instance, some embodiments of the invention may select the polymeric material to comprise the same or a similar polymer as a polymer comprising the microcapsules. In some presently preferred embodiments of the invention, the polymeric material may be selected to be sufficiently non-reactive with the temperature regulating material so that a desired temperature stabilizing range is maintained.

Depending upon the particular application of the coated article, the coating may further comprise one or more additives, such as, by way of example and not limitation, water, surfactants, dispersants, anti-foam agents (e.g., silicone containing compounds and fluorine containing compounds), thickeners (e.g., polyacrylic acid, cellulose esters and their derivatives, and polyvinyl alcohols), foam stabilizers (e.g., inorganic salts of fatty acids or their sulfate partial esters and anionic surfactants), antioxidants (e.g., hindered phenols and phosphites), thermal stabilizers (e.g., phosphites, organophosphorous compounds, metal salts of organic carboxylic acids, and phenolic compounds), light or UV stabilizers (e.g., hydroxy benzoates, hindered hydroxy benzoates, and hindered amines), microwave absorbing additives (e.g., multifunctional primary alcohols, glycerine, and carbon), reinforcing fibers (e.g., carbon fibers, aramid fibers, and glass fibers), conductive fibers or particles (e.g., graphite or activated carbon fibers or particles), lubricants, process aids (e.g., metal salts of fatty acids, fatty acid esters, fatty acid ethers, fatty acid amides, sulfonamides, polysiloxanes, organophosphorous compounds, silicon containing compounds, fluorine containing compounds, and phenolic polyethers), fire retardants (e.g., halogenated compounds, phosphorous compounds, organophosphates, organobromides, alumina trihydrate, melamine derivatives, magnesium hydroxide, antimony compounds, antimony oxide, and boron compounds), anti-blocking additives (e.g., silica, talc, zeolites, metal carbonates, and organic polymers), anti-fogging additives (e.g., non-ionic surfactants, glycerol esters, polyglycerol esters, sorbitan esters and their ethoxylates, nonyl phenyl ethoxylates, and alcohol ethyoxylates), anti-static additives (e.g., non-ionics such as fatty acid esters, ethoxylated alkylamines, diethanolamides, and ethoxylated alcohol; anionics such as alkylsulfonates and alkylphosphates; cationics such as metal salts of chlorides, methosulfates or nitrates, and quaternary ammonium compounds; and amphoterics such as alkylbetaines), anti-microbials (e.g., arsenic compounds, sulfur, copper compounds, isothiazolins phthalamides, carbamates, silver base inorganic agents, silver zinc zeolites, silver copper zeolites, silver zeolites, metal oxides, and silicates), crosslinkers or controlled degradation agents (e.g., peroxides, azo compounds, and silanes), colorants, pigments, dyes, fluorescent whitening agents or optical brighteners (e.g., bis-benzoxazoles, phenylcoumarins, and bis-(styryl)biphenyls), fillers (e.g., natural minerals and metals such as oxides, hydroxides, carbonates, sulfates, and silicates; talc; clay; wollastonite; graphite; carbon black; carbon fibers; glass fibers and beads; ceramic fibers and beads; metal fibers and beads; flours; and fibers of natural or synthetic origin such as fibers of wood, starch, or cellulose flours), coupling agents (e.g., silanes, titanates, zirconates, fatty acid salts, anhydrides, epoxies, and unsaturated polymeric acids), reinforcement agents, crystallization or nucleation agents (e.g., any material which increases or improves the crystallinity in a polymer, such as to improve rate/kinetics of crystal growth, number of crystals grown, or type of crystals grown), and so forth. The one or more additives may be dispersed uniformly, or non-uniformly, within the coating. Typically, the one or more additives will be selected to be sufficiently non-reactive with the temperature regulating material so that a desired temperature stabilizing range is maintained.

According to some embodiments of the invention, certain treatments or additional coatings may be applied to the coated article to impart properties such as, by way of example and not limitation, stain resistance, water repellency, softer feel, and moisture management properties. Exemplary treatments and coatings include Epic by Nextec Applications Inc., Intera by Intera Technologies, Inc., Zonyl Fabric Protectors by DuPont Inc., Scotchgard by 3M Co., 3XDRY, NanoSphere, c-change, etc. by Schoeller Textil AG, Coolest Comfort, Repels Stains, by Nano-Tex, Inc., and so forth.

A coated article in accordance with various embodiments of the invention may be manufactured using a variety of methods. According to some embodiments of the invention, one or more temperature regulating materials may be mixed with a polymeric material to form a blend. For some embodiments of the invention, a temperature regulating material may comprise microcapsules containing one or more phase change materials. If desired, the microcapsules may be wetted with water to facilitate their handling. The polymeric material may be provided as a liquid in a variety of forms (e.g., molten form, emulsion form, dissolved in water or an organic solvent, and so forth). According to some embodiments of the invention, monomer units or low molecular weight polymers may be initially provided, which, upon curing, drying, crosslinking, reacting, or solidifying, are converted to a polymeric material having a desired molecular weight or chain structure.

As discussed previously, one or more additives may be added when forming the blend. For instance, a surfactant may be added to decrease interfacial surface tension and promote wetting of the temperature regulating material, or a dispersant may be added to promote uniform dispersion or incorporation of a higher loading level of the temperature regulating material in the blend. If desired, a thickener may be added to adjust the viscosity of blend to reduce or prevent the temperature regulating material from sinking, or an anti-foam agent may be added to remove trapped air bubbles formed during mixing.

By way of example and not limitation, the blend may be formed as described in the patent of Zuckerman, et al., entitled “Fabric Coating Composition Containing Energy Absorbing Phase Change Material”, U.S. Pat. No. 6,207,738, issued Mar. 27, 2001, and in the published PCT patent application of Zuckerman, et al., entitled “Energy Absorbing Fabric Coating and Manufacturing Method”, International Publication No. WO 95/34609, published Dec. 21, 1995, the disclosure of which are incorporated herein by reference in their entirety. Both of the above applications are commonly assigned to Outlast Technologies, Inc. of Boulder, Colo., the assignee of the present application.

According to some embodiments of the invention, the blend may be foamed using a variety of methods, such as, by way of example and not limitation, mechanical foaming or chemical foaming. For example, the blend may be pumped through an Oakes mixer or other mechanical roamer that injects air into the blend. For such embodiments of the invention, it may be desired, but not required, that a foam stabilizer be added to the blend. Foaming the blend may result in a coating (e.g., a foamed coating) that provides improved flexibility, softness, air permeability, or water vapor transport properties to the coated article.

Once formed, the blend may be applied to or deposited on one or more surfaces of a substrate using a variety coating processes, such as, by way of example and not limitation, roll coating (e.g., direct gravure coating, reverse gravure coating, differential offset gravure coating, or reverse roll coating), screen coating, spray coating (e.g., air atomized spraying, airless atomized spraying, or electrostatic spraying), extrusion coating, and so forth. For instance, in a roll coating process, the substrate may be passed between a pair of rolls, and at least one of these rolls typically is an applicator roll that applies the blend to the substrate. In particular, the applicator roll may be engraved or etched with cells that apply the blend to the substrate in a regular or irregular pattern. Alternatively or in conjunction, a third engraved roll may apply the blend to the substrate through a smooth applicator roll. In a screen coating process, a rotary screen (e.g., a rotating screen cylinder) may be used to apply the blend to the substrate. In particular, the blend may be spread on an inner wall of the rotary screen and applied to the substrate in regular or irregular pattern through screen holes formed in the rotary screen. In a spray coating process, the blend may be sprayed onto the substrate in a regular or irregular pattern. In an extrusion coating process, the blend may be extruded to form a film or sheet having a regular or irregular pattern, and this film or sheet may then be attached or bonded to the substrate using a variety of methods.

It should be recognized that transfer coating techniques may be used with the various coating processes described above. In particular, the blend may be first applied to a carrier sheet and then transferred from the carrier sheet to the substrate. According to some embodiments of the invention, the blend may be applied to the substrate to form a continuous coating covering the substrate, and one or more portions of this continuous coating may be removed using a variety of chemical, mechanical, thermal, or electromagnetic methods to result in a coating formed in a regular or irregular pattern. By way of example and not limitation, the continuous coating may be perforated using needles to form small diameter holes as described in the co-pending and co-owned patent application of Worley, entitled “Micro-perforated Temperature Regulating Fabrics, Garments and Articles Having Improved Softness, Flexibility, Breathability and Moisture Vapor Transport Properties”, U.S. Application Publication No. 20020132091. The details of this reference are incorporated by reference in its entirety into the present disclosure.

After the blend has been applied to the substrate, the blend may be cured, dried, crosslinked, reacted, or solidified to form a coating covering the substrate. The resulting coated article may then be further processed to form a variety of products having enhanced reversible thermal properties. More particularly, fabrics and fibers may be formed that include a plurality of different phase change materials arranged in one of several ways in order to achieve a fiber or fabric that exhibits a phased response to changes in temperature.

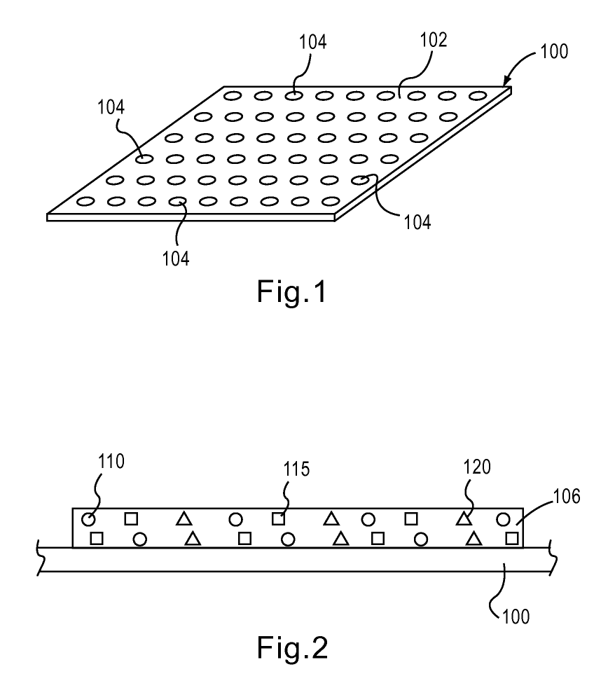

By way of example only, FIGS. 1-8 illustrate various embodiments of a coated article or fabric constructed in accordance with one or more aspects of the present invention as well as examples of methods of manufacturing such articles or fabrics. One of skill in the art will recognize that the combinations of different phase change materials, low versus high-temperature phase change materials, and various concentrations of these different phase change materials are within the scope of this disclosure. The figures referenced herein are not meant to be limiting in any way and should not be construed to be exclusive to the scope of the claims.

FIG. 1 illustrates a substrate 100 that includes on its surface a coating comprising a polymeric material and a phase change material dispersed within the polymeric material. The coating forms a region of discontinuity where some portions of the substrate are exposed and where other portions of the substrate are covered by the coating. In FIG. 1, regions 102 and 104 represent these regions of discontinuity. It is contemplated that either of regions 102 or 104 may comprise the exposed regions or the coated regions depending on the application as well as the portion of the substrate desired to be coated with the phase change material and the portion of the substrate desired to be exposed. In addition, various geometries and patterns of the coated region and exposed regions are contemplated in order to alter the performance characteristics and feel of the coated article.

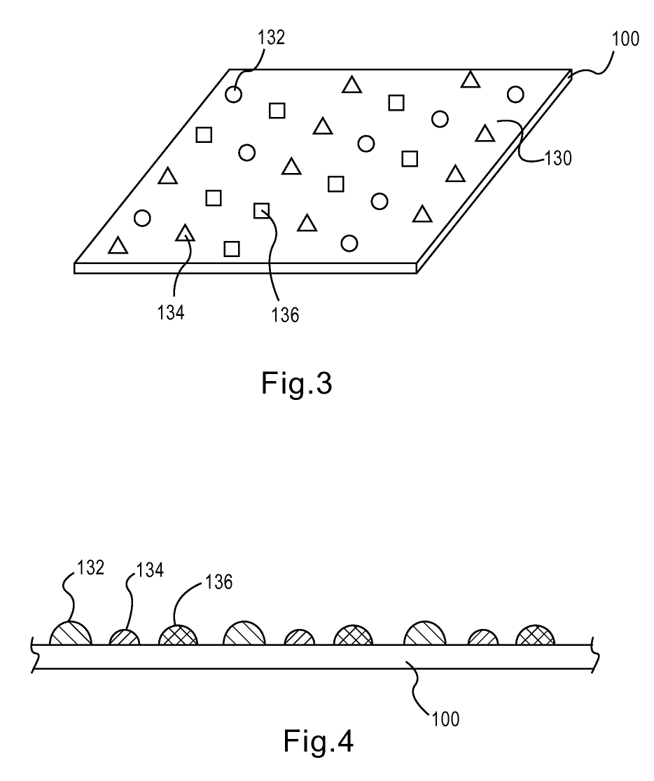

FIG. 2 shows a cross section of the coated regions(s) of FIG. 1 and the presence of three separate phase change materials 110, 115, and 120 within one of the coated regions 106. Preferably, although not required, each of the plurality of phase change materials 110, 115, and 120 are encapsulated by a micro-encapsulation technique. The shapes represented in FIGS. 1 and 2 are meant for differentiation purposes only and it is contemplated that any of the phase change materials discussed herein can be used in the corresponding microcapsules. As shown in FIG. 3, the coated region 106 may include a plurality of different phase change materials. If encapsulated as discussed above, each of the phase change materials retains its individual performance characteristics and thus provides a phase response to a rapid change in temperatures.

FIG. 3 again shows the substrate 100 that includes on its surface a coating comprising a polymeric material and a phase change material dispersed within the polymeric material. The coating forms a region of discontinuity where some portions 130 of the substrate are exposed and where other portions of the substrate are covered by the coating. In FIG. 3, coated regions are represented by regions 132, 134 and 136, where each of these separate regions contain a phase change material and preferably a different phase change material in each of the plurality of regions. FIG. 4 shows a cross section of the substrate 100 and the plurality of coated regions 132, 134, and 136 of FIG. 3. Preferably, although not required, each of the plurality of phase change materials 132, 134, and 136 are encapsulated. The shapes represented in FIGS. 3 and 4 are meant for differentiation purposes only and it is contemplated that any of the phase change materials discussed herein can be used in the corresponding microcapsules.

The phase change materials contained within regions 132, 134, and 136 can be distributed across the surface of the substrate 100 in order to effect a phased response to rapid changes in temperature. For example, region 132 might contain a lower temperature phase change material, and regions 134 and 136 contain gradually higher temperature phase change materials. Because each of the regions will exhibit a different phase change transition temperature, the article constructed as such will provide temperature buffering across a wide range of temperatures and through a rapid change of temperatures.

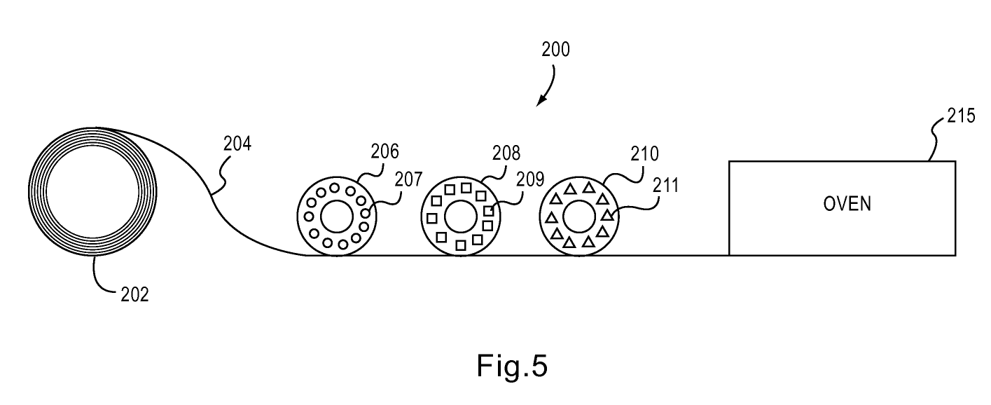

FIG. 5 represents a schematic diagram of a manufacturing method used in conjunction with various aspects of the present invention. In order to print or otherwise apply several different phase change materials to a single substrate 202, several screens are utilized where a first screen 206 includes a first pattern 207 that distributes a first phase change material onto the substrate. Likewise, a second screen 208 includes a second pattern 209 that distributes a second phase change material onto the substrate and a third screen 210 includes a third pattern 211 that distributes a third phase change material onto the substrate. An oven 215 then dries the substrate that has been coated with the several patterns of phase change materials.

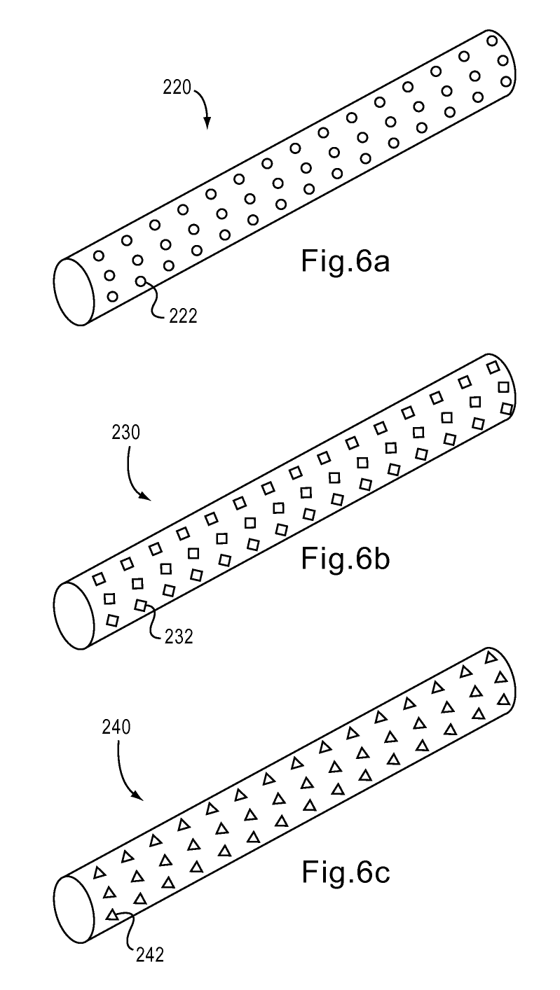

FIGS. 6A-6C shows details of the different screens 220, 230 and 240 used in conjunction with the manufacturing method of FIG. 5 where screen 220 has printing pattern 222, screen 230 has printing pattern 232 and screen 240 has printing pattern 242. Various combinations of the screens and printing patterns may be utilized in order to customize a phase response coating in accordance with aspects of the present invention. As discussed above, different phase change materials may be used with each of the screens and printing patterns in order to further customize the performance characteristics of a resulting fabric or substrate.

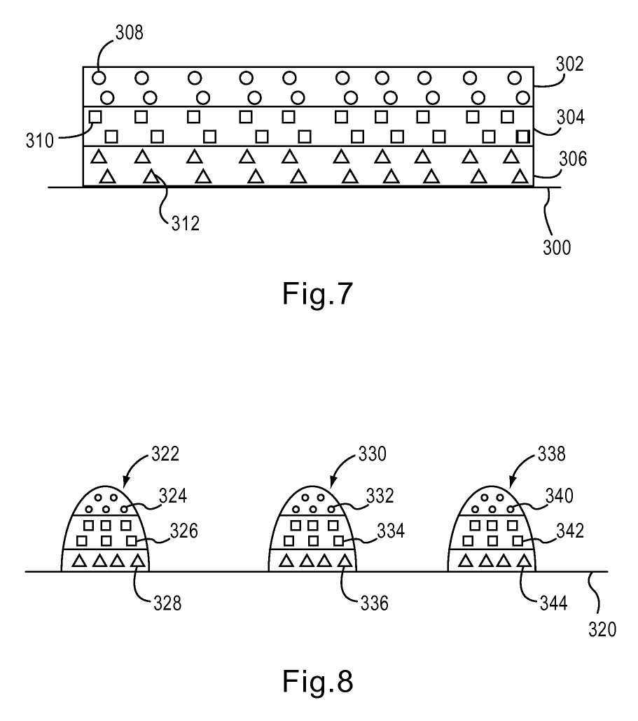

FIG. 7 shows a substrate 300 coated with a plurality of layers 302, 304 and 306. Each of the layers 302, 204 and 306 preferably contain a separate phase change material 308, 310, and 312 respectively. As above, each of the phase change materials 302, 204 and 306 comprise a different temperature phase change material such that the combination of the various layers provides for a phase response to rapid temperature changes. FIG. 8 shows a cross section of the substrate 300 and an embodiment where the layers of phase change materials are distributed within one or more coated regions of the substrate 300.

It should be recognized that the polymeric material need not be used for certain applications of the coated article. For instance, the temperature regulating material may comprise a polymeric phase change material having a desired transition temperature, and this polymeric phase change material may be used to form the coating without requiring the polymeric material. The polymeric phase change material may be provided as a liquid in a variety of forms (e.g., molten form, emulsion form, dissolved in water or an organic solvent, and so forth). According to some embodiments of the invention, monomer units or low molecular weight polymers may be initially provided, which, upon curing, drying, crosslinking, reacting, or solidifying, are converted to the polymeric phase change material having a desired molecular weight or chain structure. If desired, one or more additives may be added to the polymeric phase change material to form a blend. The polymeric phase change material may be applied to or deposited on one or more surfaces of the substrate using a variety coating processes as described above and then cured, dried, crosslinked, reacted, or solidified to form a coating covering the substrate.

### EXAMPLES

The following examples describe specific aspects of the invention to illustrate and provide a description of the invention for those of ordinary skill in the art. The examples should not be construed as limiting the invention, as the examples merely provide specific methodology useful in understanding and practicing the invention.

### Example 1

A water-based acrylic resin coating blend (65 percent of dry weight of microcapsules containing a staged phase change material based on total dry weight of solids, supplied as BR-5152 by Basic Adhesives Inc., Carlstadt, N.J.) was adjusted for viscosity and applied to a substrate using a rotary screen. The rotary screen (manufactured by vanVeen-Bell, Easton, Pa.) was a 30 mesh metal screen with screen pattern #0T03 produced on it. This pattern provided 75 percent surface coverage with a circular dot pattern. The substrate used was a 140 g/m² 100% polyester micro fleece lining (Vendor Style: A001606, supplied by Ching-Mei Textile Corp., Taiwan). The coating blend was applied to the substrate at 200 g/m² and then dried in a forced air oven for 10 minutes at 130° C. to yield a flexible, air permeable coating with a circular dot pattern. The final weight of the coating was 100 g/m², which yielded 65 g/m² of the microcapsules containing the phase change material.

### Example 2

A water-based acrylic resin coating blend (65 percent of dry weight of microcapsules containing a staged phase change material based on total dry weight of solids, supplied as BR-5152 by Basic Adhesives Inc., Carlstadt, N.J.) was adjusted for viscosity and applied to a substrate using a rotary screen. The rotary screen (manufactured by vanVeen-Bell, Easton, Pa.) was a 30 mesh metal screen with screen pattern #0T03 produced on it. This pattern provided 75 percent surface coverage with a circular dot pattern. The substrate used was a 150 g/m² 100% polyester apertured non-woven fabric (supplied by Tiong Liong Corp., Taiwan). The coating blend was applied to the substrate at 230 g/m² and then dried in a forced air oven for 10 minutes at 130° C. to yield a flexible, air permeable coating with a circular dot pattern. The final weight of the coating was 115 g/m², which yielded 75 g/m² of the microcapsules containing the phase change material

### Example 3

A low molecular weight polyethylene homopolymers (AC-16 polyethylene, drop point 1020 C., manufactured by Honeywell Specialty Chemical) was added to a wet flushing apparatus and the homopolymers was slowly melted and mixed at about 1100° C. to about 1300° C. Once the homopolymer was melted, a wet cake comprising water-wetted microcapsules containing a phase change material with a staged temperature transition was slowly added to the molten polymer over approximately 30 minutes to from a blend. Water was flashed off as the microcapsules containing the staged phase change material was added and dispersed in the molten polymer. Mixing was continued until less than about 0.1% by weight of water remained (as measured using Karl-Fischer titration.) The resulting blend was then cooled and pelletized for further processing. A dry blend was then formed by adding the pelletized material to pellets of fiber grade polypropylene thermoplastic polymer (Polypropylene homopolymers 6852 manufactured by BP Amoco Polymers). The term “staged” or “phased” temperature transitions, without being limited by terminology, is broadly used to describe the ability of a phase change material to absorb rapid body temperature without causing an immediate chilling effect. Typically this can be achieved by having overlapping phase changes as opposed to a single sharp transition.

The resulting dry blend was then extruded using a 2.5 inch single screw extruder with all zones set at about 2300° C., with a screw speed of about 70 rpm, with 150 mesh filter screens and with a nitrogen purge. In this manner, pellets were formed.

### Example 4

Effect of PCM loadings and PCM melt temperatures on the subjective cool feeling and length of time of cool feeling.

Various fabrics were coated with different loadings and formulations containing different blends of PCM microcapsules. With reference to the table below, microencapsulated PCM 41 had a melt temperature of 28° C. and PCM 42 had a melt temperature of 33° C. The formulations were either a 75/25 blend, a 50/50 blend or 100% of PCM 41/PCM 42. The fabrics were coated with either 5.7 ounces/yd² or 3.5 ounces/yd² to give a high and low PCM concentration. The fabrics were conditioned then evaluated by 18 different subjects for the preferred coolness and length of coolness versus the non-PCM control. The conclusion shown is that the higher the concentration of PCM and the lower the PCM melt temperature provides for a longer and cooler feeling.

TABLE 3
Subjective Results - Time of Cool Feel

| | 5.7 osy | 5.7 osy | 3.5 osy | 3.5 osy | 3.5 osy | |
|---|---|---|---|---|---|---|
| Evaluator | 75/25 | 50/50 | 75/25 | 50/50 | PCM42 | Control |
| 1 | 34 | 39 | 16 | 23 | 13 | 9 |
| 2 | 58 | 73 | 51 | 62 | 19 | 16 |
| 3 | 34 | 34 | 31 | 30 | 22 | 13 |
| 4 | 74 | 35 | 18 | 20 | 13 | 13 |
| 5 | 43 | 38 | 32 | 33 | 14 | 12 |
| 6 | 70 | 112 | 45 | | | 14 |
| 7 | 45 | 51 | 102 | 26 | 22 | 18 |
| 8 | 59 | 91 | 49 | 34 | 26 | 26 |
| 9 | 51 | 48 | 40 | | | 13 |
| 10 | 69 | 91 | 49 | | | 26 |
| 11 | 46 | 40 | 41 | 22 | 23 | 12 |
| 12 | 22 | 30 | 24 | 18 | 15 | 8 |
| 13 | 82 | 72 | 67 | | | 21 |
| 14 | 41 | 56 | 26 | 57 | 17 | 10 |
| 15 | 28 | 25 | 22 | 27 | 21 | 8 |
| 16 | 49 | 45 | 53 | 26 | 18 | 12 |
| 17 | 35 | 51 | 36 | 21 | 17 | 15 |
| 18 | 47 | 76 | 25 | 22 | 13 | 10 |
| Average | 49.3 | 55.9 | 40.4 | 30.1 | 18.1 | 14.2 |

A water-based acrylic resin coating blend (70 percent of dry weight of microcapsules containing a staged phase change material based on total dry weight of solids, supplied as CA50039 by CHT R. Beitlich Corp., Charlotte N.C.) was adjusted for viscosity and applied to a substrate using a rotary screen. The rotary screen (manufactured by Rothtec Engraving Corp., Charlotte N.C.) was a 30 mesh metal screen that provided 55 percent surface coverage with a circular dot pattern. The substrate used was a 40 g/m² 100% polyester non-woven fabric (supplied by Polimeros y Derivados, S.A, de C.V., Mexico). The coating blend was applied to the substrate at 137 g/m² and then dried in a forced air oven for 30 seconds at 150° C. to yield a flexible, air permeable coating with a circular dot pattern. The final weight of the coating was 110 g/m², which yielded 70 g/m² of the microcapsules containing the phase change materials.

These coated products with varying blends of microencapsulated PCMs were then tested versus ASTM D7024.

Additionally, U.S. Pat. No. 7,160,612, the details of which are incorporated by reference in its entirety, presents examples that can be modified to include a mixture of waxes capable of providing a phased temperature response.

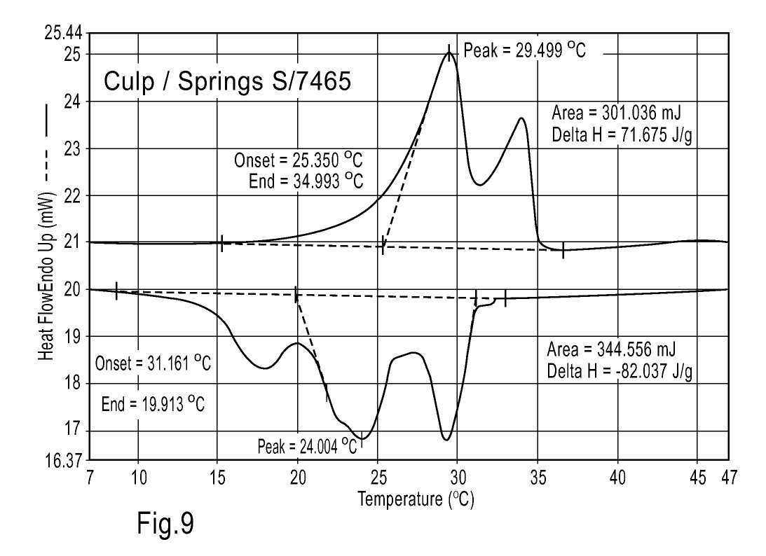

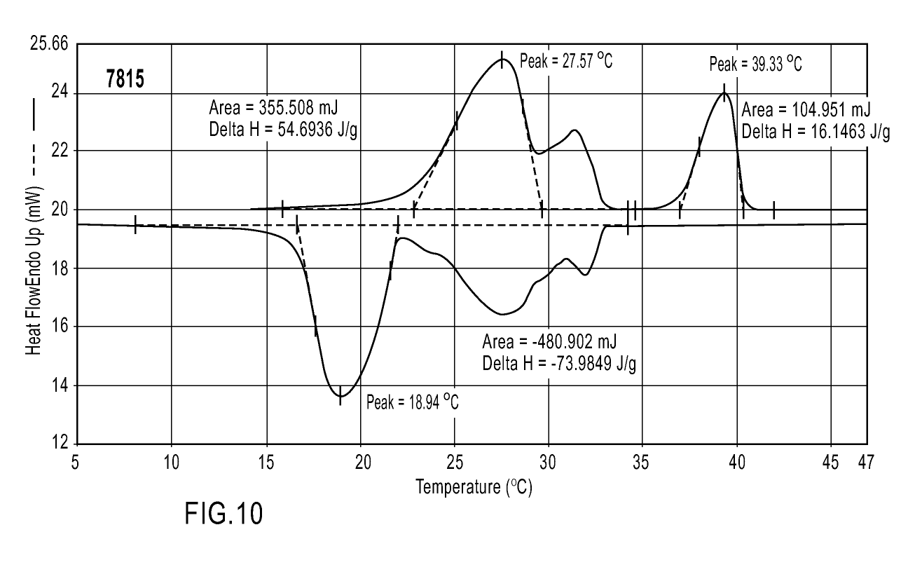

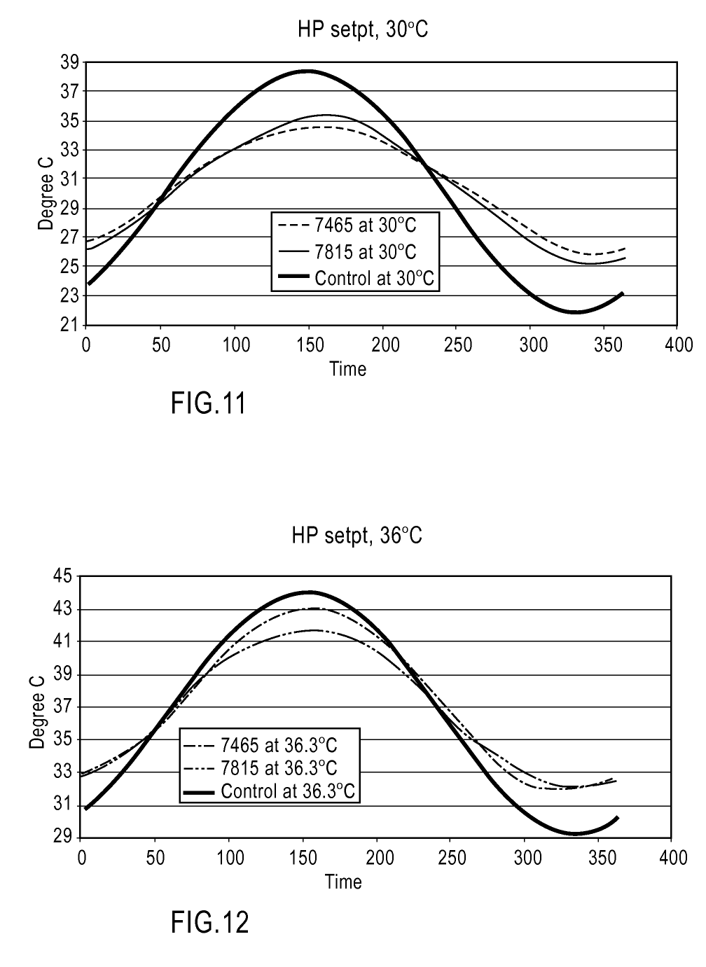

FIGS. 9-12 show the results of various additional tests on articles constructed in accordance with various aspects of the present invention. FIGS. 9 and 10 show the results of a standard DSC test in which the heating or melting curve is on the top and cooling or crystallization curve is on the bottom. FIGS. 11 and 12 are the result of the ASTM D7024 test. In summary, the results of these tests show that the addition of 20% of a high temperature phase change material greatly improves the high temperature buffering needed for menopause and other “hot flash” applications. Specific results indicate that PCM containing fabrics show greater temperature buffering properties versus a control without PCM. For example, in FIGS. 11 and 12, this is shown by the control having the greatest temperature amplitude, or difference between Tmax and Tmin. In FIGS. 11 and 12, sample 7465 is the lower temperature PCM combination (as shown in the DSC graph of FIG. 9) which gives it improved temperature buffering properties at a lower testing temperature (e.g. 30° C. FIG. 11). The addition of a higher temperature PCM (37M) in sample 7815 (as shown in DSC graph of FIG. 10) shows the improved temperature buffering properties at a higher menopause “hot flash” temperature (e.g. 36.3° C.). This is shown in the 7815 sample having the lowest temperature amplitude (as shown in FIG. 12)

Each of the patent applications, patents, publications, and other published documents mentioned or referred to in this specification is herein incorporated by reference in its entirety, to the same extent as if each individual patent application, patent, publication, and other published document was specifically and individually indicated to be incorporated by reference.

While aspects of the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

For example, other aspects of a product construction in accordance with one or more aspects of the present invention include the substrate comprising either a fabric, film, foam, or leather.

What is claimed is:

1. A coated article for providing a phased response to rapid temperature changes, comprising:
a substrate;
a coating disposed on a portion of the substrate, the coating comprising:
a polymeric material;
a first temperature regulating material having a transition temperature between 22° C. and 50° C. and disposed within a first plurality of microcapsules; and
a second temperature regulating material having a transition temperature between 25° C. and 45° C. and disposed within a second plurality of microcapsules;
wherein the first temperature regulating material and the second temperature regulating material are dispersed in the polymeric material; and
a plurality of regions of discontinuity formed by the coating, the plurality of regions of discontinuity creating exposed portions of the substrate to provide improved flexibility and air permeability to the coated article;
wherein the coating provides a buffered response to rapid temperature changes.

2. The coated article of claim 1, further comprising a third temperature regulating material having a transition temperature between 30° C. and 45° C. and disposed within a third plurality of microcapsules.

3. The coated article of claim 1, wherein the coating comprises between 15% and 25% of the first temperature regulating material.

4. The coated article of claim 1, wherein the coating comprises between 15% and 50% of the first temperature regulating material.

5. The coated article of claim 1, wherein the regions of discontinuity are distributed substantially uniformly across the surface of the substrate.

6. The coated article of claim 1, wherein the coating covers up to 99 percent of the surface of the substrate.

7. The coated article of claim 1, wherein the coating covers between 50 and 90 percent of the surface of the substrate.

8. The coated article of claim 1, wherein the coating is formed in a pattern selected from the group consisting of a crisscross pattern, a grid pattern, a honeycomb pattern, or a randomly generated pattern.

9. The coated article of claim 1 wherein at least one region of discontinuity has a first shape and at least one region of discontinuity has a second shape.

10. The coated article of claim 1, wherein the plurality of regions of discontinuity have shapes that are selected from the group consisting of circular, half-circular, diamond-shaped, hexagonal, multi-lobal, octagonal, oval, pentagonal, rectangular, square-shaped, star-shaped, trapezoidal, triangular, and wedge-shaped.

11. The coated article of claim 1, wherein the plurality of regions of discontinuity have sizes ranging from 1 mm² to 10 mm².

12. The coated article of claim 1, wherein the plurality of regions of discontinuity have sizes ranging from 1 mm² to 4 mm².

13. The coated article of claim 1, wherein the substrate is selected from the group consisting of a fabric, film, foam, or leather.

14. The coated article of claim 1, wherein the temperature regulating material comprises an absorbent material impregnated with a phase change material.

15. The coated article of claim 1, wherein the temperature regulating material comprises a solid/solid phase change material.

16. The coated article of claim 1, wherein the temperature regulating material comprises a polymeric phase change material.

17. A fabric providing a phased response to rapid temperature changes, comprising:
a first surface;
a coating disposed on a portion of the first surface, the coating comprising:
a first temperature regulating material having a transition temperature between 22° C. and 50° C. and disposed within a first region of the coating, and
a second temperature regulating material having a transition temperature between 25° C. and 45° C. and disposed within a second region of the coating,
wherein the first temperature regulating material and the second temperature regulating material are dispersed in a polymeric material;
a plurality of regions of discontinuity formed by the coating, the plurality of regions of discontinuity creating exposed portions of the first surface to provide improved flexibility and air permeability to the coated article;
wherein the coating provides a buffered response to rapid temperature changes.

18. The fabric of claim 17, wherein the first region of the coating and the second region of the coating are contiguous.

19. The fabric of claim 17, wherein the first region of the coating and the second region of the coating are adjacent to each other on the first surface of the fabric.

20. The fabric of claim 17, wherein the first region of the coating is layered with the second region of the coating.

21. The fabric of claim 17, wherein the first region of the coating is layered on top of the second region of the coating.

22. The fabric of claim 17, further comprising a third temperature regulating material having a transition temperature between 30° C. and 45° C. and disposed within a third region of the coating.

23. A coated article for providing a phased response to rapid temperature changes, comprising:
a substrate;
a coating disposed on a portion of the substrate, the coating comprising:
a polymeric material,
a temperature regulating material having a transition temperature between 22° C. and 50° C. and disposed within a plurality of microcapsules;
wherein the temperature regulating material is dispersed in the polymeric material; and
a plurality of regions of discontinuity formed by the coating, the plurality of regions of discontinuity creating exposed portions of the substrate to provide improved flexibility and air permeability to the coated article;
wherein the coating provides a buffered response to rapid temperature changes.

24. A method of manufacturing a fabric, comprising:
coating the fabric with a first temperature regulating material having a transition temperature between 22° C. and 50° C., wherein the first temperature regulating material forms a first pattern on the fabric;
coating the fabric with a second temperature regulating material having a transition temperature between 25° C. and 45° C., wherein the second temperature regulating material forms a second pattern on the fabric;
wherein the first pattern and the second pattern form regions of discontinuity that create exposed portions of the fabric to provide improved flexibility and air permeability to the coated article; and
wherein the first and second temperature regulating materials provide a buffered response to rapid temperature changes.

25. The method of claim 24, further comprising coating the fabric with a third temperature regulating material having a transition temperature between 30° C. and 45° C., wherein the third temperature regulating material forms a third pattern on the fabric.
